(19) United States
(12) Patent Application Publication
(10) Pub. No.: US 2005/0087957 A1
(43) Pub. Date: Apr. 28, 2005

(54) Riser seat and wheelchairs with same

(76) Inventors: John E. Bennett, Rancho Palos Verdes, CA (US); Willis C. Bradley, Gardena, CA (US); Leah Rotter, Los Angeles, CA (US)

Correspondence Address: Natan Epstein, Esp.;Law Offices of Natan Epstein, 11377 West Olympic Boulevard, Los Angeles, CA, 90064, US

(21) Appl. No.: 10/692,698

(22) Filed: Oct. 23, 2003

(51) Int. Cl. B62B 3/00

(52) U.S. Cl. 280/647

(57) ABSTRACT

An adjustable height seat for a wheelchair has a seat supported on a telescoping support. The seat rises and lowers in response to repositioning of the user's body weight on the seat. A spring normally urges the seat towards an elevated condition. The seat is depressed when the user's body assumes a relatively reclined position to overcome upward urging of the spring. Conversely, the seat rises when the user's body weight is partially rested on a ground surface allowing the spring to lift the seated user's remaining body weight. The telescoping support is frictionally arrested in a generally upright or forward leaning position of the seated user. The adjustable height seat can be installed in a wheelchair frame either permanently or interchangeably with a conventional wheelchair seat.

### BACKGROUND OF THE INVENTION

1. Field of the Invention

This invention relates generally to a height adjustable seat and particularly a height adjustable seat suitable for use in wheelchairs.

2. State of the Prior Art

Various efforts have been made towards providing seats which can assist feeble person in rising from and sitting down on the seat. It is also known to provide wheelchairs with a mechanism designed to help the user rise from a seated position to a standing position.

A need exists for a seat capable of raising a seated user to a more convenient height to facilitate certain tasks, such as reaching for merchandise on store shelving while shopping or working on a kitchen counter top, for example. It is especially desirable to provide such a height adjustable seat which is responsive to repositioning of the user's body on the seat, and to provide such capability in a seat suitable for installation in wheelchairs, including folding wheelchairs.

### SUMMARY OF THE INVENTION

This invention provides a height adjustable or riser seat which is responsive to repositioning of the user's body weight on the seat.

The adjustable height seat has a chair frame, a seat supported on a movable member slidable relatively to a stationary member on the frame, a spring normally urging the movable member towards an elevated condition, the movable member and the stationary member being arranged and configured such that the movable member is arrested against movement relative to the stationary member in a generally normal upright or forward leaning seated position of the user such that the seat remains at a selected position relative to the frame, and the body weight of the user overcomes the urging of the spring in a relatively reclining position of the user thereby to depress the movable member for lowering the seat on the frame, and the seat can be raised on the frame by partially offloading the user's body weight from the seat onto a ground surface such that the spring overcomes the user's remaining body weight on the seat thereby elevating the movable member and the seat. The movable member and the stationary member may be assembled in telescoping relationship to provide a telescoping support in which the movable member can be arrested by frictional engagement with a stationary member.

The adjustable height seat of this invention may be also understood as having a chair frame, a telescoping support mounted to the chair frame, a seat supported on the telescoping support, a spring normally urging said telescoping support towards an elevated condition, the telescoping support being operative for raising and lowering the seat relative to the chair frame responsive to repositioning of a user's body weight on the seat. The chair frame may be of any suitable design, and may be a wheelchair frame including a folding wheelchair frame. In the case of a folding wheelchair frame, one or both of the movable and stationary members may be removable from the chair frame to permit folding of the chair frame.

Preferably, the seat is depressed from an elevated to a lowered position when the user's body assumes a relatively reclined position wherein the user's body weight overcomes said urging of said spring. Conversely, the seat may be elevated from a lowered position if the user's body is partially offloaded from said seat onto a ground surface such that said spring overcomes the user's remaining body weight on said seat and causes telescoping extension of said telescoping support for raising said seat relative to said frame. The telescoping support is frictionally arrested against substantial telescoping movement in a generally upright or forward leaning seated position of the user on said seat for holding the seat at a desired position.

In one form of the invention the telescoping support is inclined away from the vertical. In the case where the chair frame has a back, a front and two sides, the telescoping support may be inclined towards the front between the sides.

In one possible configuration the telescoping support has an upper member telescopically slidable relative to a lower member, and the seat is mounted on the upper member. The upper and lower members may be tubular members of rectangular cross section telescopically slidable relative each other, for example, the upper member slidable within the lower member. The spring, such as a gas spring, may be contained in the tubular upper and lower members.

In one embodiment of the invention the adjustable height or riser seat is installed in a folding wheelchair of the type generally comprising a wheel chair frame having left and right frame subassemblies, a scissor arrangement including a center pivot interconnecting the frame subassemblies for movement towards and away from each other between a deployed condition and a folded condition of the wheel chair. The telescoping support and seat are mounted between the frame subassemblies.

In one form of the invention the telescoping support is mounted in a riser seat frame which is removably suspended from the wheelchair frame. The riser seat frame is removed from the wheelchair frame to permit folding of the wheelchair frame or to install a non-rising seat as a replacement for the riser seat.

In another form of the invention a lower member of the telescoping support is permanently mounted to the wheelchair frame, and the seat attached to an upper member of the telescoping support is removable from the permanently mounted lower member to allow folding of the wheelchair.

The height adjustable seat can be installed in a folding wheelchair frame of the type having a folding scissor arrangement with cross braces for interconnecting two side frame subassemblies. In such case the telescoping support may be supported at the center pivot of the scissor arrangement, and a second support point may be provided by foldable slide braces included in the scissor arrangement thereby to hold the telescoping support upright between the frame subassemblies.

In an alternate form of the invention suitable for folding and non-folding wheel chair frames, the telescoping support is mounted on a removable riser seat frame adapted to be suspended between the frame subassemblies of the wheel chair and to be removed for folding of the wheel chair frame or for replacing the riser seat with a non-rising seat. The removable riser seat frame can be installed in a wheel chair frame as a replacement for a conventional wheelchair seat. The riser seat frame may be of adjustable width to fit wheel chair frames of different width.

The removable riser seat frame may have a pair of transverse supports connected by a pair of longitudinal beams, with the telescoping support being mounted between the longitudinal beams. Hanger brackets may be provided on each of the transverse supports for suspending the riser seat frame from the left and right frame subassemblies of the wheelchair frame. The transverse supports are of telescoping length for adjusting the spacing between the hanger brackets thereby to fit wheel chair frames of different width, and fasteners may be provided for fixing the length of the transverse supports.

These and other improvements, advantages and features of this invention will be better understood by reference to the detailed description of the preferred embodiments set forth below, taken in conjunction with the accompanying drawings.

### BRIEF DESCRIPTION OF THE DRAWINGS

FIG. 1 is a right side elevational view of a wheel chair with a height adjustable riser seat on a removable riser seat frame;

FIG. 2 is a fragmentary front view of the riser seat and frame of FIG. 1 supported on the wheel chair's side frames;

FIG. 3 is a perspective view of the removable riser seat frame of FIG. 1 with the seat and upper telescoping member removed to show the upper end of the gas spring extending from the stationary lower member of the telescoping support;

FIG. 4 is a vertical cross section of the telescoping support of FIG. 1 shown in fully retracted condition and the seat in fully depressed position;

FIG. 5 is a front elevational view of the scissor arrangement of a folding wheel chair frame equipped with a height adjustable riser seat;

FIG. 6 shows the scissor arrangement of FIG. 5 in folded condition;

FIG. 7 is a section taken along line 7-7 in FIG. 5;

FIG. 8 is a section taken along line 8-8 in FIG. 5;

FIG. 9 is a section taken along line 9-9 in FIG. 5; and

FIG. 10 is a section taken along line 10-10 in FIG. 5.

### DETAILED DESCRIPTION OF THE PREFERRED EMBODIMENTS

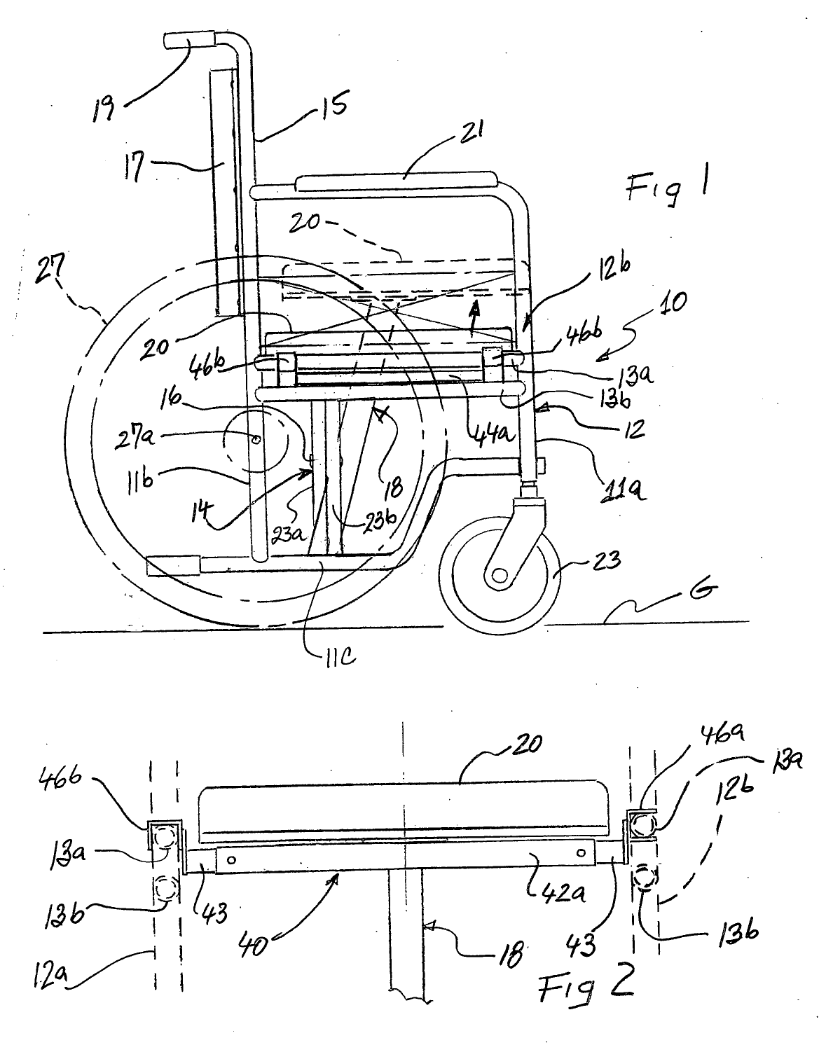

With reference to the accompanying drawings wherein like elements are designated by like numerals, FIG. 1 shows a wheel chair generally designated by numeral 10 which has a non-folding wheel chair frame 12 having left and right side frames 12a, 12b. Each side frame has two legs, including a front leg 11a and a rear leg 11b, two horizontal cross members 13a, 13b and an arm rest 21 between the front and rear leg. A bottom runner 11c connects the lower ends of front and rear legs 11a,11b. The rear leg 11a has an extended upper portion which supports one side of a back rest 17 and terminates in a handle 19. A castor wheel 23 is attached to the front leg 11a and a larger wheel 27 is mounted to rear leg 11b on axle 27a. The two side frames 12a, 12b are interconnected by cross members 23a,23b joined at their intersection by a center fastener 16.

A telescoping support 18 is mounted between the side frame subassemblies 12a, 12b, and a seat 20 is supported on an upper end of the telescoping support 18 for movement between a lowered and an elevated condition, shown in solid and phantom lining, respectively, in FIG. 1.

The telescoping support 18 has two tubular members 26, 28 which may be steel tubes of rectangular cross section, assembled in sliding telescoping relationship as best seen in FIG. 4. The lower, outer tubular member 28 has a closed bottom 25 and an upper end 29. The upper, inner member 26 is telescopically slidable into and out of outer member 28. The outside cross section of inner member 26 is slightly undersized to the internal cross section of outer member 26. The upper end 32 of upper member 26 is closed by a plate 31 which supports the seat 20 at the upper end of the telescoping support 18. A gas spring 22 is contained in compression between closed bottom 25 and plate 31 for normally urging the telescoping support 18 towards extension and the seat 20 towards an elevated condition. The gas spring 22 has a gas cylinder 22a and a piston rod 22b driven upwardly against the underside of seat 20 by the gas compressed in the gas cylinder 22a.

In general, the adjustable height seat of this invention has a seat 20 supported on a movable member 26 slidable relatively to a stationary member 28 supported on the frame 12, such as wheel chair frame 12 in FIG. 1, a spring such as gas spring 22 normally urging the movable member 26 towards an elevated condition, the movable member 26 and the stationary member 28 being arranged and configured such that the movable member 26 is arrested against movement relative to the stationary member 28 in a generally normal upright or forward leaning seated position of a user on seat 20 such that the seat 20 remains at a selected position relative to the frame 12, and the body weight of the user overcomes the urging of the spring 22 in a relatively reclining position of the user thereby to depress the movable member 26 for lowering the seat on the frame 12, and the seat 20 can be raised on the frame 12 by partially offloading the user's body weight from the seat 20 onto a ground surface G such that the spring 22 overcomes the user's remaining body weight on the seat 20 thereby elevating the movable member 26 and the seat 20. The movable member 26 and the stationary member 28 may be assembled in telescoping relationship to provide a telescoping support 18 in which the movable member 26 can be arrested by frictional engagement with a stationary member 28.

In the embodiment of FIGS. 1 through 4 the telescoping support 18 is mounted at an inclined angle θ such as about 15 degrees to the vertical within a vertical plane contained between and generally parallel to the side frame subassemblies 12a, 12b. The support 18 is inclined towards the front of the chair frame 12 in FIG. 1.

The seat 20 is located in relation to the telescoping support 18 so that the center of gravity of the user while in a generally upright or slightly forward leaning seated position applies a substantial transverse force to the upper end of slidable inner member 26, forcing the forward side 26a of tubular member 26 into frictional engagement against the inside of tubular member 28. For example, the center of gravity of the user's body weight may be located just forward of the top end 32 of telescoping support 18 when the user is seated in that position. This frictional engagement operates as a brake to arrest the tubular members 26, 28 against relative telescoping displacement and to thereby hold seat 20 at a selected elevated position relative to the wheel chair frame 12.

A friction plate 30 may be welded at the top of the lower tubular member 26 with an inside edge 30a oriented for engaging the inside surface 28a of the upper member 28 so as to enhance frictional engagement as the upper member 28 is urged against the inside edge 30a by the user's body weight on seat 20.

This frictional engagement between the telescoping members 26, 28 can be controlled by adjustment and repositioning of the seated user's body weight on seat 20.

The user on seat 20 can reduce the frictional braking force between the telescoping members 26, 28 by leaning back or reclining on seat 20, thereby shifting the center of gravity of his or her body weight rearwards of the top end 32 of the telescoping support, thereby reducing the transverse force component and consequently the frictional engagement between the telescoping members. Such shift in body weight frees the tubular members 26, 28 for sliding telescoping displacement relative to each other, and allows the body weight of the seated user to overcome the upward urging of the gas spring 22. The gas spring is chosen to have a spring force appropriate to the body weight of the user so as to allow the user's body weight to compress the gas spring in this manner. Normally, the gas spring is chosen to have a spring force lesser than the body weight of the user for this reason.

Conversely, the seated user is able to elevate seat 20 to a convenient height by partially offloading his or her body weight from seat 20 sufficiently to allow the upward force of spring 20 to overcome the remaining body weight on seat 20 to be lifted along with the seat by the spring force. The user can accomplish this offloading by placing his or her feet on the ground G in front of the wheelchair 10 and resting part of his or her body weight onto the ground surface G, thereby reducing the body weight bearing down seat 20 until the spring force overcomes the remaining body weight, causing extension of the telescoping support and raising the seat 20.

The user can stop the seat at an elevated position by assuming the aforementioned upright or slightly forward leaning seated position on seat 20, thereby again causing the inner member 26 to bear against the friction plate 30 thereby arresting further telescoping displacement between the telescoping members 26, 28.

The user can assist in changing the elevation of the seat both up and down by pushing down or pulling up on the armrests 21 of the wheelchair 10.

In the first embodiment of this invention shown in FIGS. 1 through 4, the telescoping support 18 with seat 20 is mounted on a removable riser seat frame 40 which can be installed in a wheelchair having either a folding or non-folding wheelchair frame such as frame 12. In this first embodiment telescoping support 18 is mounted on a riser seat frame 40 adapted to be removably suspended between side frame subassemblies 12a, 12b of the wheel chair frame 12. The removable frame 40 is preferably of adjustable width so as to fit wheel chairs having different widths between frame subassemblies 12, 12b. The frame can be lifted away from the frame 12 and carried or stored separately, while wheelchair frame 12 can be folded for storage or transport.

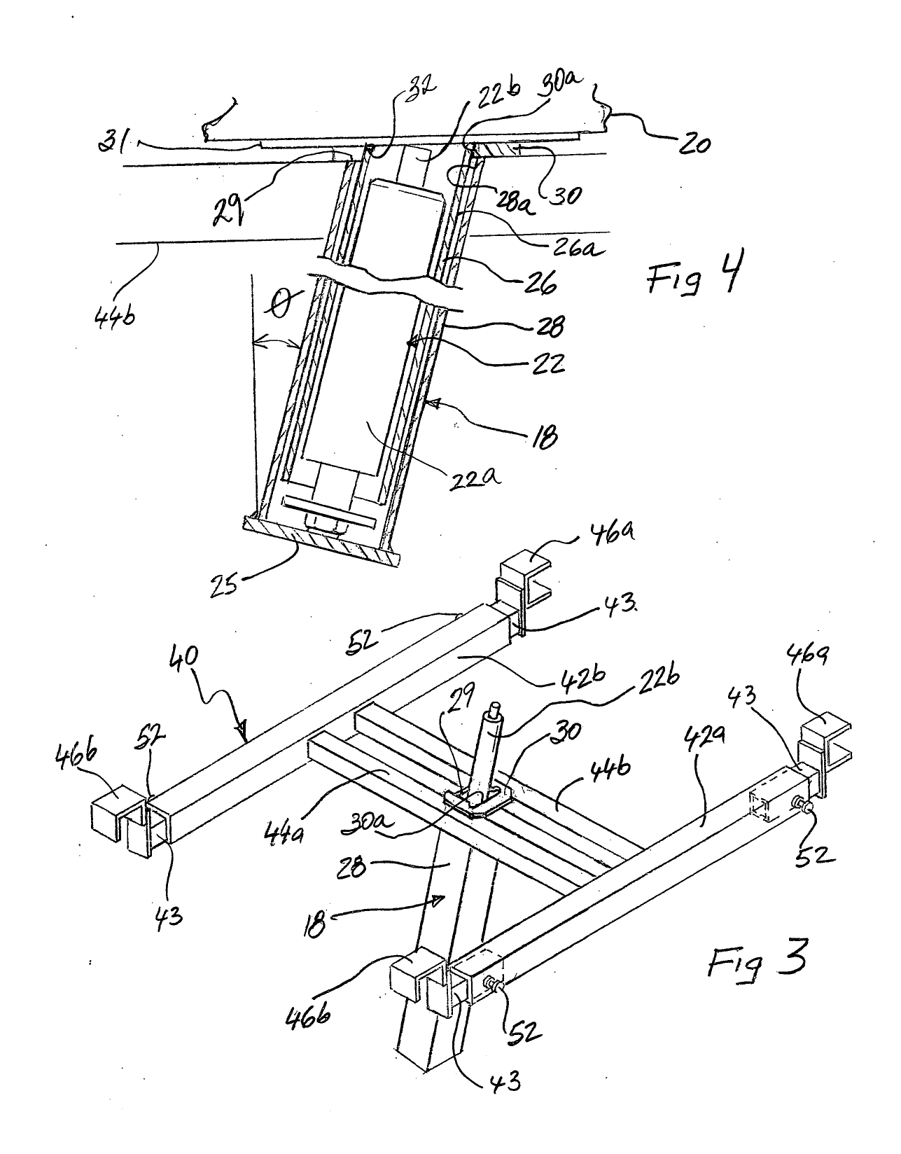

For example, as best understood by reference to FIG. 3 the riser seat frame 40 has a pair of transverse supports 42a, 42b connected by a pair of longitudinal beams 44a, 44b, with the telescoping support 18 mounted between the longitudinal beams 44a, 44b. The top end 29 of the outer tubular member 28 is suspended from friction plate 30 which spans cross beams 44a, 44b. Hanger brackets 46 are provided on each of the transverse supports 42a, 42b for suspending frame 40 from frame subassemblies 12a, 12b of the wheelchair frame 12. The transverse supports 42a, 42b may have telescoping ends 43 for adjusting the spacing between the hanger brackets and thereby effectively adjust the width of frame 40. Fasteners 52 may be provided for fixing the length of the transverse supports at a desired width of frame 40. In FIG. 3 the seat 20 together with the inner tubular member 26 have been removed from the telescoping support 18 for clarity of illustration, allowing the piston rod 22b of the gas spring 22 to extend from the open upper end 29 of the outer tubular member 28.

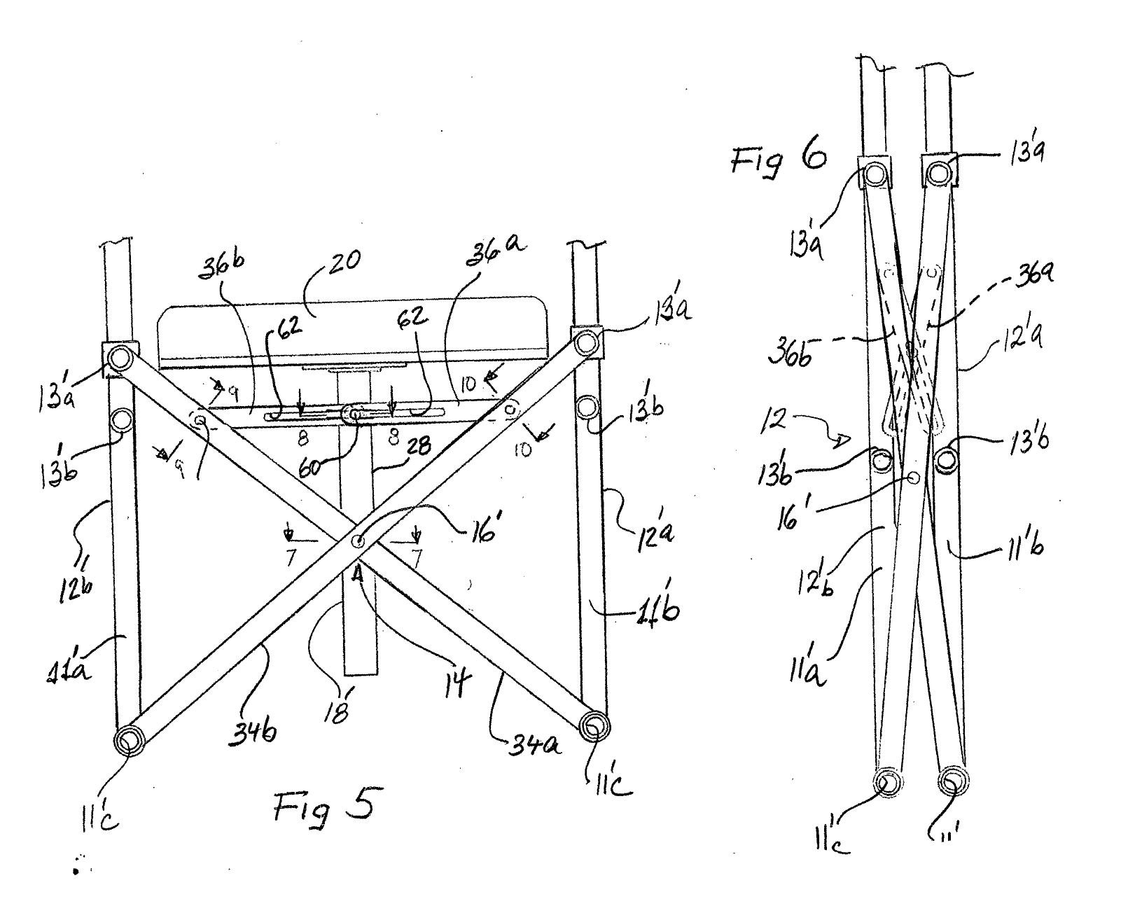

A second embodiment of the invention shown in FIGS. 5 through 10 is a height adjustable seat installed in an otherwise conventional folding frame wheelchair. The folding wheel chair frame has left and right side frame subassemblies 12′a, 12′b similar to those shown in FIG. 1 but interconnected by a scissor arrangement which folds as shown in FIG. 6 to bring together the side frames. The seat and backrest may be foldable slings or are removable from the frame prior to folding.

FIG. 5 shows a scissor arrangement 14 such as used in some existing folding wheel chair frames. The scissor arrangement 14 includes diagonal cross braces 34a, 34b interconnecting side frame subassemblies 12′a, 12′b and joined for scissor movement at center pivot 16′. The lower ends of cross braces 34a, 34b are fastened to sleeves 82 rotatable about lower cross member 84 of frame 12′. The upper ends of the cross braces 34a, 34b are pivotably attached to cross member 13′a which itself is supported on sliding sleeves 86. Sleeves 86 are slidable up and down along front and rear legs 11′a, 11′b, between the deployed position of FIG. 5 and the folded position of FIG. 6.

The telescoping support 18′ is supported firstly at center pivot 16′. Foldable slide braces 36a, 36b provide a second support point for the telescoping support 18′ in a deployed condition of the scissor assembly 14 to maintain the telescoping support 18′ upright on the wheelchair frame 12′. The upper member 26 of the telescoping support is removable together with seat 20 from the lower member 28 to allow folding of the wheel chair frame 12′ as in FIG. 6.

It will be noted that in the second embodiment of FIGS. 5 and 6 the telescoping support 18′ is generally vertical and is not inclined away from the vertical as in the first embodiment of FIGS. 1-4. Nevertheless the telescoping support 18′ operates substantially as described in connection with telescoping support 18 of the first embodiment. This is because there is some play between the telescoping members sufficient to allow the internal member to tilt at a slight angle inside the external tubular member in response to a forward shift of the center of gravity of the seated user's body weight. This tilting brings the inside member into frictional engagement with a front top edge of the outside member, while the bottom end of the inside member is torqued in an opposite direction into frictional engagement against a rear inside surface of the outside member. The frictional engagement and consequent arresting or braking of the telescoping displacement is controlled by repositioning of the user's body weight on the seat 20 in a manner analogous to the operation described in connection with the telescoping support 18 of the first embodiment of FIGS. 1-4.

FIGS. 7 through 10 are detail cross sections showing certain aspects of the scissor assembly of the folding wheelchair frame.

FIG. 7 illustrates the center pivot 16′ at which cross members 34a, 34b pivot about a common pivot bolt 50 which passes through aligned diametric holes in each of the cross members. A nut 52 retains the cross members on bolt 50. A washer 54 is placed on the bolt 50 between the cross members. A spacer sleeve 56 on bolt 50 keeps the cross members away from bolt head 58. The bolt head 58 is welded to outer tubular member 28 of the telescoping support 18′ and provides a first point of support for telescoping support 18.

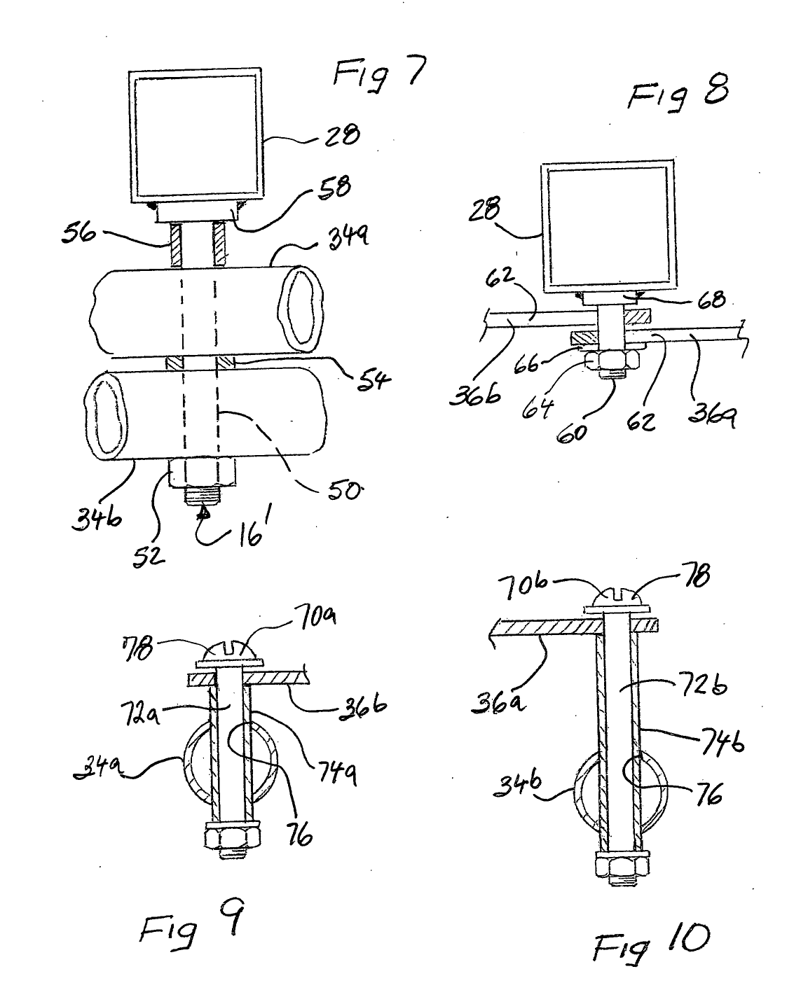

FIG. 8 shows how the sliding braces 36a, 36b are connected at their inner ends by a bolt 60 which passes through slots 62 in the sliding braces. The braces are retained on the bolt by a nut 64 and washer 66. The bolt head 68 of bolt 60 is welded to outer tubular member 28 of the telescoping support 18′ and provides a second point of support for telescoping support 18′.

FIGS. 9 and 10 show how the outer ends of slide braces 36a, 36b are pivoted to cross members 34a, 34b respectively on pin shafts 72a, 72b of pivot pins 70a, 70b respectively. Each pin shaft passes through a mounting sleeve 74a, 74b. Each sleeve 74a, 74b passes through a diametric hole 76 in cross members 34a, 34b respectively. The slide braces 36a, 36b are captive on the respective pin shafts between the sleeves 74a, 74b and pin head 78.

The adjustable height seat described in connection with the foregoing first and second embodiments can be also implemented in chair frames or installations other than wheelchairs. The telescoping supports 18, 18′ can be mounted in any suitable manner on stationary frames for use as a stationary seat of adjustable height. For example, the riser seat frame 40 of FIG. 3 can be fitted with legs or otherwise supported at a convenient height on a ground surface. In such case the operation of the adjustable height seat by a user is analogous to that described in connection with the wheelchair mounted embodiments above.

Preferred embodiments of the invention have been described and illustrated for purposes of clarity and example. However, it must be understood that many changes, modifications and substitutions to the described embodiments will be apparent to those having only ordinary skill in the art without thereby departing from the scope of this invention, which is defined by the following claims.

1. An adjustable height seat, comprising:
a chair frame, a telescoping support mounted to said chair frame, a seat supported on said telescoping support, a spring normally urging said telescoping support towards an elevated condition, said telescoping support being operative for raising and lowering said seat relative to said chair frame responsive to repositioning of a user's body weight on said seat.

2. The adjustable height seat of claim 1 wherein said seat is depressed from an elevated to a lowered position when the user's body assumes a relatively reclined position wherein the user's body weight overcomes said urging of said spring.

3. The adjustable height seat of claim 1 wherein said seat is elevated from a lowered position when the user's body is partially offloaded from said seat onto a ground surface such that said spring overcomes the user's remaining body weight on said seat and causes telescoping extension of said telescoping support for raising said seat relative to said frame.

4. The adjustable height seat of any of claims 1 through 3 wherein said telescoping support is frictionally arrested against substantial telescoping movement in a generally upright or forward leaning seated position of the user on said seat.

5. The adjustable height seat of claim 4 wherein said telescoping support is inclined away from the vertical.

6. The adjustable height seat of claim 5 wherein said chair has a back, a front and two sides and said telescoping support is inclined towards said front between said sides.

7. The adjustable height seat of any of claims 1 through 3 wherein said telescoping support has an upper member telescopically slidable relative to a lower member, said seat being mounted on said upper member.

8. The adjustable height seat of claim 1 through 3 wherein said telescoping support has tubular upper and lower members telescopically slidable relative each other and said spring is contained in said tubular upper and lower members.

10. The adjustable height seat of claim 8 wherein said upper member and said lower member are of rectangular cross section.

11. The adjustable height seat of claim 8 wherein said upper member is slidable within said lower member.

12. The adjustable height seat of claim 8 wherein said spring is a gas spring.

13. The adjustable height seat of claim 1 wherein said chair frame is a wheel chair frame.

14. The adjustable height seat of claim 13 wherein said wheel chair frame is a folding wheel chair frame.

15. The adjustable height seat of claim 13 or claim 14 wherein said telescoping support is removably mounted to said wheel chair frame.

16. An adjustable height seat, comprising:
a chair frame, a seat supported on a movable member slidable relatively to a stationary member on said frame, a spring normally urging said movable member towards an elevated condition, said movable member and said stationary member being arranged and configured such that said movable member is arrested against movement relative to said stationary member in a generally normal seated position of the user such that said seat remains at a selected position relative to said frame, and the body weight of said user overcomes said urging of the spring in a relatively reclining position of the user thereby to depress said movable member for lowering said seat on said frame, and said seat can be raised on said frame by partially offloading the user's body weight from said seat onto a ground surface such that said spring overcomes the user's remaining body weight on said seat thereby elevating said movable member and said seat.

17. The adjustable height seat of claims 16 wherein said movable member is arrested by frictional engagement with said stationary member.

18. The adjustable height seat of claim 17 wherein said movable member and said stationary member are assembled in telescoping relationship.

19. The adjustable height seat of claim 16 wherein said chair frame is a foldable chair frame and one or both of said movable member and said stationary member are removable from said chair frame to permit folding of said chair frame.

20. A folding wheel chair with riser seat, comprising:
a wheel chair frame having left and right frame subassemblies, a scissor arrangement including a center pivot interconnecting said frame subassemblies for movement towards and away from each other between a deployed condition and a folded condition of the wheel chair, a telescoping support mounted between said frame subassemblies, a seat supported on said telescoping support for movement between a lowered and an elevated condition, said telescoping support being operative for raising and lowering said seat relative to said chair frame responsive to repositioning of a user's body weight on said seat relative to said telescoping support, said seat being removable from between said frame subassemblies to permit folding of the wheelchair frame.

21. The folding wheel chair with riser seat of claim 20 wherein said telescoping support comprises a spring normally urging said telescoping support towards said elevated condition.

22. The folding wheel chair with riser seat of claim 21 wherein said telescoping support is designed, arranged and configured such that a frictional force between members of said telescoping support is reduced when a user reclines on said seat and the body weight of said user overcomes said urging of said spring thereby to cause telescoping retraction of said support for lowering said seat on said frame.

23. The folding wheel chair with riser seat of claim 21 wherein said seat is elevated on said frame in response to the user partially shifting his or her body weight onto a ground surface such that said spring overcomes the user's body weight remaining on said seat and causes telescoping extension of said telescoping support for raising said seat relative to said frame.

24. The folding wheel chair with riser seat of any of claims 20 through 23 wherein said telescoping support has at least two tubular members assembled in sliding telescoping relationship.

25. The folding wheel chair with riser seat of claim 24 wherein said telescoping support has an upper member telescopically slidable relative to a lower member, said seat being mounted on said upper member, and a spring contained in said upper member and said lower member for urging said upper member and said seat towards said elevated condition.

26. The folding wheel chair with riser seat of any of claims 20 through 23 wherein said telescoping support is supported at said center pivot between said frame subassemblies.

27. The folding wheel chair with riser seat of claim 26 wherein said scissor arrangement includes cross braces interconnecting said frame subassemblies and joined for scissor movement at said center pivot, and foldable slide braces arranged for providing a second support point for said telescoping support in said deployed condition of the wheelchair thereby to maintain said telescoping support upright between said frame subassemblies.

28. The folding wheel chair with riser seat of any of claims 20 through 23 and 25 wherein said telescoping support is mounted on a riser seat frame, said riser seat frame being removably supported on said wheel chair frame in a deployed condition of said wheel chair.

29. The folding wheel chair with riser seat of claim 28 wherein said frame is of adjustable width thereby to fit wheel chair frames of different width between said frame subassemblies.

30. The folding wheel chair with riser seat of claim 28 wherein said frame has a pair of transverse supports connected by a pair of longitudinal beams, said telescoping support being mounted between said longitudinal beams.

31. The folding wheel chair with riser seat of claim 28 wherein said frame has a pair of transverse supports and hanger brackets on each of said transverse supports for suspending said frame from said frame subassemblies.

32. The folding wheel chair with riser seat of claim 31 wherein said transverse supports are of telescoping length for adjusting the spacing between said hanger brackets.

33. The folding wheel chair with riser seat of claim 32 further comprising fasteners for fixing said length of said transverse supports.

34. A riser seat for installation in a wheelchair of the type having left and right frame subassemblies and a non-rising seat removably suspended between said subassemblies, said riser seat comprising:
a removable frame adapted to be removably suspended between said frame subassemblies interchangeably with said non-rising seat, a telescoping support mounted on said removable frame, a seat on said telescoping support, a spring for urging said telescoping support towards an upwardly extended condition thereby to elevate said seat relative to said removable frame, said telescoping support being operative for raising and lowering said seat relative to said removable frame responsive to repositioning of a user's body weight on said seat.

35. The riser seat of claim 34 wherein said removable frame is of adjustable width thereby to fit wheel chairs of different width between said removable frame subassemblies.

36. The riser seat of claim 34 wherein said removable frame has a pair of transverse supports connected by a pair of longitudinal beams, said telescoping support being mounted between said longitudinal beams.

37. The riser seat of claim 36 wherein said removable frame has a pair of transverse supports and hanger brackets on each of said transverse supports for suspending said removable frame from said frame subassemblies.

38. The riser seat of claim 37 wherein said transverse supports are of telescoping length for adjusting the spacing between said hanger brackets.

39. The riser seat of claim 38 further comprising fasteners for fixing said length of said transverse supports.
